(19) United States
(12) Patent Application Publication
(10) Pub. No.: US 2008/0208472 A1
(43) Pub. Date: Aug. 28, 2008

(54) Traffic Safety System

(76) Inventor: Christopher John Morcom, Kent (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/630,122

(22) PCT Filed: Jun. 22, 2005
(86) PCT No.: PCT/GB2005/002451

§ 371 Date: Dec. 20, 2007

(30) Foreign Application Priority Data
Jun. 25, 2004 (GB) 0414271.7

(51) Int. Cl. G08G 1/16

(52) U.S. Cl. 701/301

(57) ABSTRACT

A vehicle safety system comprises a collision avoidance system, comprising range finding apparatus for determining a distance to an adjacent vehicle, the collision avoidance system comprising a transmitter (74) and a receiver (70). A communications system is used for communicating with a road side terminal. The communications system uses the same transmitter and receiver respectively to send and receive data to and from the road side terminal.

This invention relates to traffic safety systems, in particular systems which provide communication between transponders carried by vehicles and road side monitoring and/or control stations.

There has been a large amount of research and development in recent years into vehicle management systems, for a number of reasons. For example, such systems are being developed for toll collection purposes, and for monitoring volumes of traffic flow. This control and monitoring can be used to tailor road development plans in order to reduce congestion and cut pollution.

In addition to these monitoring functions, there are also proposals for vehicle control systems in which some control information is provided to the vehicles, for example control signals for imposing a variable speed limit or collecting road tolls, or for vehicle to vehicle communication systems, for example to provide a faster response to vehicle braking.

These systems all share in common the provision of transponders in the vehicles and road side control units which communicate with those transponders. A variety of transmission systems have been used to carry data between the transponder and vehicles including low power radio and, for the Japanese Vehicle Information and Communication System (VICS), modulated light.

In addition, numerous vehicle safety devices have been proposed for collision warning or avoidance purposes. Such systems generally require apparatus for accurate range-finding and object detection. This enables better driver information to be provided and the active and early warning of danger, and this has lead to a variety of approaches.

The simplest collision avoidance solutions rely on measuring the distance from the vehicle to the nearest vehicle in front and providing a warning light or sound to the driver if he is driving too close, given his current speed. Optical rangefinders (ORF) or microwave ranging systems can be used for this purpose, and it has been proposed to scan the field of view of the rangefinder over the scene in front of a vehicle to measure the distance to other vehicles or obstacles.

The applicant has proposed a low cost and reliable image sensing and analysis apparatus using simple technology, which is able to measure the distance to objects over a field of view around a vehicle and enabling false and true warnings to be easily distinguished from each other. The system uses a multiple-region light detector. Furthermore, the measurement of the time of flight of light signals is achieved using cross correlation of a maximal length sequence, and with an oversampling technique which permits accurate optical time of flight measurements to be made even at the short distances associated with vehicle control systems.

The cross correlation method for distance measurement is described in more detail in WO01/55746, and the use of the technique in a system which scans a field of view is described in WO 02/082016. The use of the distance measurement technique in a collision avoidance system is described in WO 02/082201.

It is expected that vehicles will be required in future to have many different additional electronic safety systems, including the two types of system outlined above. This incremental growth in the number of different electronic systems introduced into vehicles clearly results in increased costs. Although the production volumes involved enable significant economies of scale, the additional complexity and cost is significant and the transmitter and receiver elements are typically the most costly elements in the two types of systems outline above.

According to the invention, there is provided a vehicle safety system, comprising:

a collision avoidance system, comprising range finding apparatus for determining a distance to an adjacent vehicle, the collision avoidance system comprising a transmitter and a receiver; and

a communications system for communicating with a road side terminal, the communications system using the same transmitter and receiver respectively to send and receive data to and from the road side terminal,

wherein the collision avoidance system comprises a sequence generator for generating a modulation signal, and a cross-correlator for obtaining the time delay of a time delayed reflected modulation signal from a comparison of the modulation signal and the time delayed reflected modulation signal,

and wherein the communications system comprises a modulator for providing a modulated light output, wherein the modulated output has a low cross correlation with the sequence generator sequence.

This system uses the same transmitter and receiver for range finding applications as for communication with a road infrastructure control system or other vehicles. The use of a communication system in this way enables the hardware costs associated with the two systems to be reduced. The use of a communications signal which has low cross correlation with the range finding signal enables the two systems to operate simultaneously.

The sequence generator can provide as output a maximal length sequence, or a maximal length sequence extended by a plurality of bits.

The shared receiver of the communications system and the collision avoidance system preferably comprises an optical receiver.

The sequence generator may comprise a maximal length sequence generator. For example, the sequence generator can generates a repeating sequence of length k·2^{r-1} bits, wherein 2^{r-1} is the length of a maximal length sequence and k is an oversampling factor. The k·2^{r-1} bits are preferably transmitted at a bit rate such that they have a transmission duration of 1-10 microseconds. This is a range suitable for a collision avoidance application.

One way to provide the low cross correlation is to modulate the communications signal on a carrier signal having a frequency corresponding to the clock rate of the analogue to digital converter used to sample the received reflected optical signal.

An alternative way is to provide a bit period of the communications signal to correspond to the transmission duration of the k·2^{r-1} bits. Each bit of the communications signal can comprise one of two possible patterns of 0 and 1 within the bit period.

The collision avoidance system may further comprise:

means for illuminating a field of view of interest with an optical transmitter output signal; and

receiving optics for receiving light reflected from the field of view to be analysed,

wherein an optical receiver comprises a multiple-region light detector for detecting light received from the receiving optics, wherein different regions of the light detector can be actuated separately.

This separate actuation of the regions of the light detector enables the range finding measurements to be made over many points in the field of view of the detector. However, the optical receiver can also be used in a full integrating mode for detection of communications signals.

The collision avoidance system may further comprise:

control electronics to synchronise the timing and direction of emissions of the transmitter and the actuation of the receiver; and

processing means for measuring the time of flight of signals from the transmitter to the receiver and deriving distances from the times of flight.

The collision avoidance system may further comprise a maximal length sequence generator for generating a modulation signal, and a cross-correlator for obtaining the time delay of a time delayed reflected modulation signal from a comparison of the modulation signal and the time delayed reflected modulation signal. This cross correlation technique provides an accurate measurement of delay, and thereby distance, whilst using a relatively low sampling rate. The cross correlator can be arranged to carry out the steps of: determining, at a coarse resolution, the time delay of the modulation signal needed to maximise the correlation between the time delayed modulation signal and the modulation signal; determining at a finer resolution than the coarse resolution, the correlation between the time delayed modulation signal and modulation signal as a function of the time delay of the time delayed modulation signal with respect to the modulation signal in a time delay range around the determined time delay; and outputting a measure of distance calculated from the time delay of the modulation signal needed to maximise the correlation between the time delayed modulation signal and the modulation signal.

The communications system preferably comprises a modulator for providing a modulated output, wherein the modulated output has a low cross correlation with the maximal length sequence of the collision avoidance system.

Examples of the invention will now be described in detail with reference to the accompanying drawings, in which:

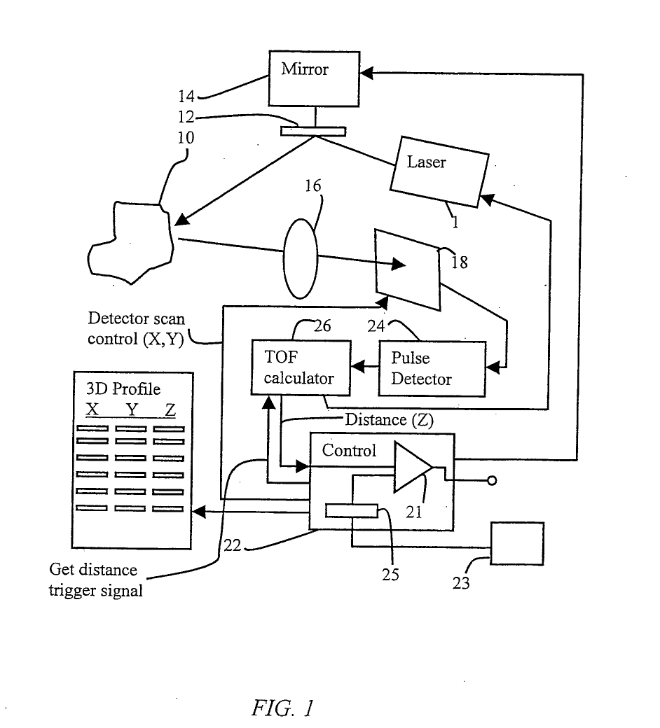

FIG. 1 shows a known collision avoidance system which is used in the system of the invention;

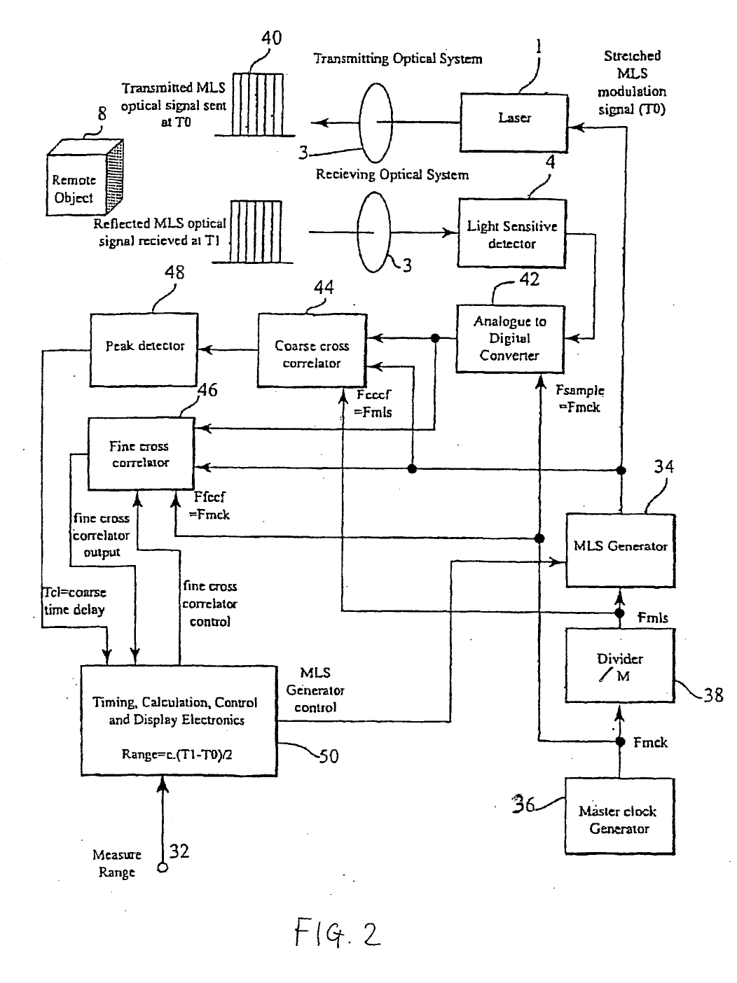

FIG. 2 shows in more detail collision avoidance system using cross correlation of MLS sequences for distance measurement;

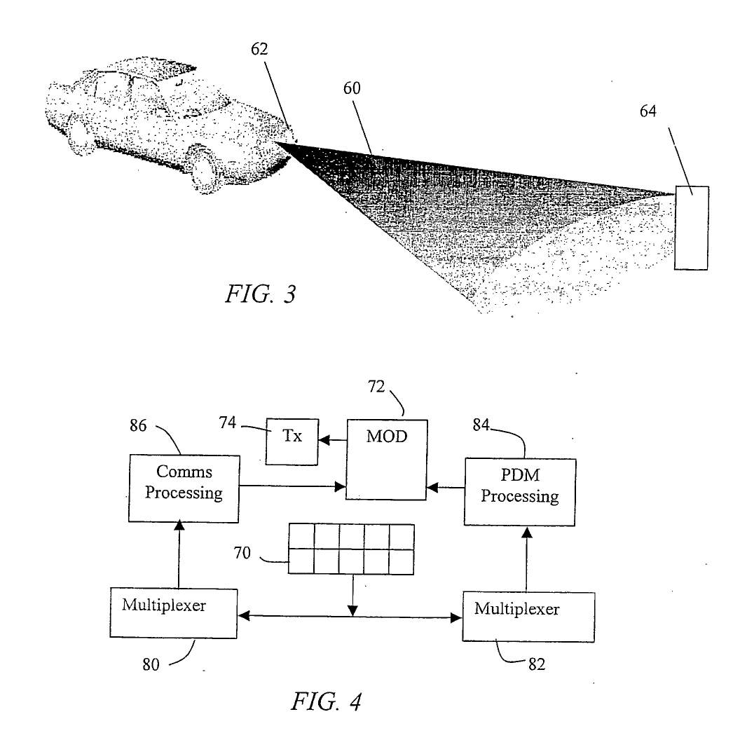

FIG. 3 shows a vehicle communicating with a road-side transponder;

FIG. 4 shows a system of the invention;

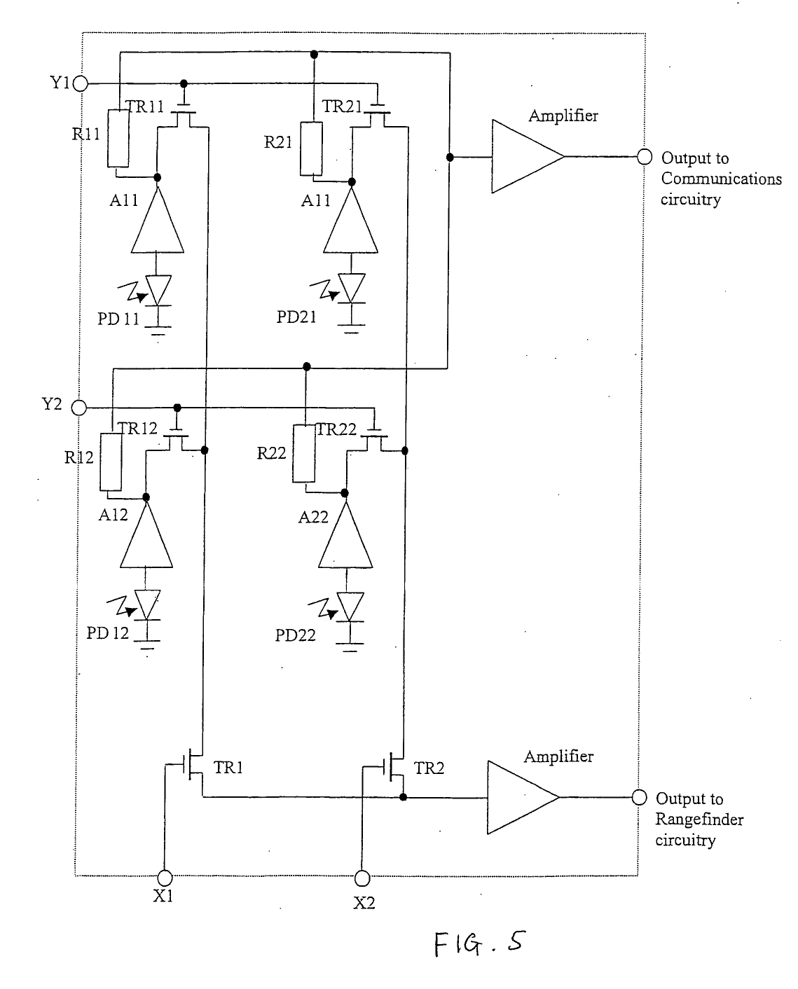

FIG. 5 shows a photodiode array for use in the system of the invention;

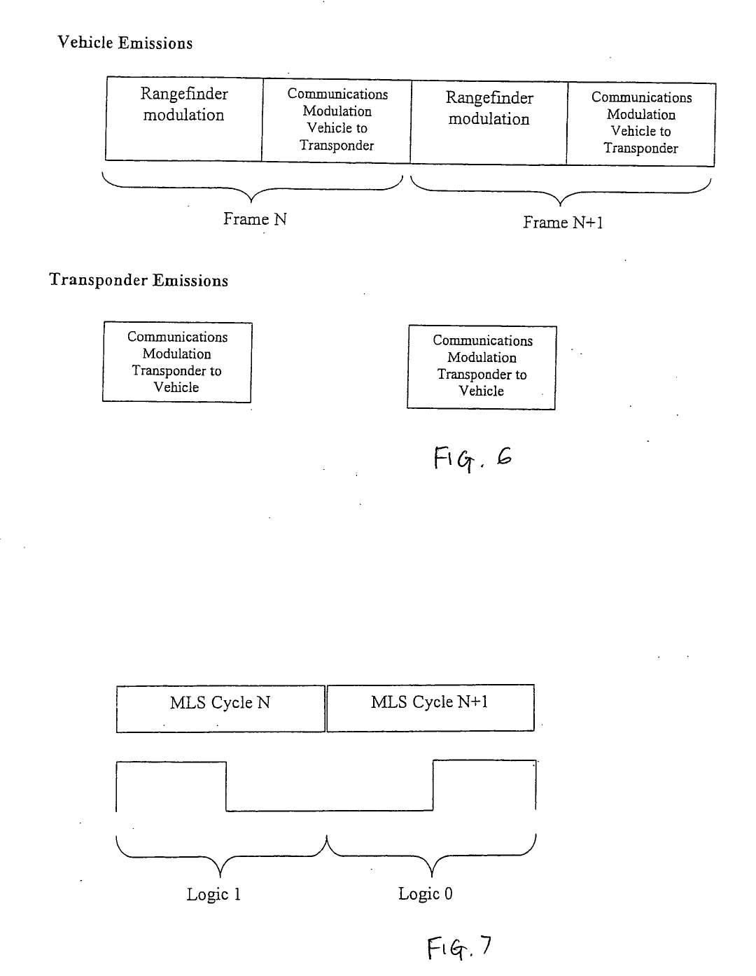

FIG. 6 shows an example frame structure for combining range-finding and communications signals; and

FIG. 7 shows a phase shifted modulation scheme for use in the system of the invention.

The invention provides a safety system which combines a collision avoidance system, using optical range finding apparatus, and a communications system for communicating with a road side terminal. The communications system uses the optical transmitter and the optical receiver of the collision avoidance system.

The collision avoidance system used in the combined system of the invention may be as described in WO 02/082201 which is hereby incorporated by reference. A brief discussion of the features of that system which are of particular relevance to the present invention will first be provided.

The simplest version of the collision avoidance system is illustrated in FIG. 1.

A sequentially pulsed laser beam output from a laser 1 is arranged to illuminate the field of view 10.

A stationary, receiving optical system 16 is arranged to collect all the light from the remote object and focus it onto a photodiode array 18. The photodiode array 18 is connected to a pre-amplifier, pulse discriminator 24 and timing (TOF—“time of flight”) electronics 26.

Control electronics 22 control the timing of laser pulsing. Each laser pulse is reflected from objects in the field of view 10, collected by receiving optics 16 and focused onto the photodiode array 18 to generate an electrical pulse, in a part of the array where the part of the object illuminated by the laser spot is focused.

The control electronics apply logic level signals to the relevant X and Y control lines of the X-Y addressed array so that each photodiode is sequentially connected to a pre-amplifier and time of flight detection electronics 26. The reflected laser pulse from a region of the remote object within the field of view is focussed onto and captured by this photodiode and the resultant electrical signal routed to the electrical pulse detector and time of flight (TOF) measurement circuitry 26. This computes the TOF of the laser emission to and from the region of the remote object within field of view focussed onto the photodiode on the X-Y addressed array and hence distance from this specific region of the remote object to the X-Y addressed array.

This process is repeated for many regions within the field of view to measure the range of objects within the field of view. If it is desired to change the size of the region examined by the system, the control electronics can cause the detector to address a group of adjacent photodiodes (e.g. a 2×2 sub-array of photodiodes) in parallel to optimise collection and detection of the laser energy.

Because the control electronics 22 is controlling the laser pulse timing and photodiode X-Y addressing, it is able to build up a matrix of numbers comprising the photodiode location (X,Y) and the range R(X,Y) to the remote object imaged onto the photodiode which represents the 3D surface profile of the remote object.

In this system, selected regions of the light detector can be actuated independently, and the actuation is synchronised with the timing of the light source.

The distances measured to remote objects within the field of view of the apparatus can be processed in a number of different ways to implement functions which are appropriate for a collision avoidance system. For example, the collision avoidance system may use comparison of distances with a threshold using a comparator 21 and a speed sensor 23 is provided to control the threshold.

The system may be extended by the use of a laser scanning system 44 synchronised to the photodiode array scanning to improve the system signal to noise ratio. Laser scanning may be implemented in a number of ways including using electro-magnetically or piezo-electrically scanned mirrors or by mounting a laser chip on a micro-machined silicon or compact piezo electric structure.

In the simplest implementation of the collision avoidance system, the laser output is simply pulsed on and off. However, the performance of the system can be substantially improved by providing a modulated laser output, and replacing the pulse detector 24 by a cross-correlation system. In this case, the system includes a signal source such as a laser for supplying a modulation signal and a transmission system connected to the signal source for transmitting a transmitted optical signal modulated by the modulation signal.

The modulation signal may be, for example, a maximal length sequence. This is a family of pseudo random noise binary signal (PRBS) which are typically generated using a digital shift register whose input is generated from appropriate feedback taps. The maximal length sequence is the pseudo random noise sequence with the longest period which can be generated with a shift register of r sections. It has a length of N=2^{r-1} shift register clock cycles and has good auto-correlation properties as the auto-correlation function has only two values; either −1/N or a peak of 1.0 at the point of correlation.

When an MLS sequence is used, the reception system is arranged to receive a reflected and delayed version of the transmitted signal, and a cross-correlator is used for obtaining the time delay. The cross correlator can be arranged to determine, at a coarse resolution, the time delay of the modulation signal needed to maximise the correlation between the time delayed modulation signal and the received signal. The cross correlator can then determine, at a finer resolution than the coarse resolution, the correlation between the modulation signal and the received signal as a function of the time delay of the modulation signal with respect to the received signal in a smaller time delay range around the determined time delay. A measure of distance is calculated from the time delay of the modulation signal needed to maximise the correlation between the time delayed modulation signal and the received signal.

This cross correlation technique is described in more detail in WO 01/55746 which is hereby incorporated by reference.

The cross-correlator is in practice implemented digitally, and the sampling frequency of the cross-correlator set to be a multiple of the maximal length sequence generator clock frequency. This oversampling approach enables the distance resolution of the system to be improved; and the efficient signal processing method using coarse and fine cross-correlators minimises the processing power needed.

The use of a modulated signal such as an MLS and the oversampling approach can be used to increase the system immunity to interference from other like systems being operated by nearby vehicles (e.g. in adjacent lanes). This is because the correlation peak detected in a maximal length sequence (MLS) based TOF system using a specific oversampling factor is insensitive to another MLS signal generated with a different oversampling factor. For example, there is little correlation between a MLS of oversampling factor 5 and of oversampling factor 6, even if the MLS signals are of the same order.

This preferred MLS technique is shown in FIG. 2. The modulated output is generated by a laser 1 and output through optics 3 to provide an output 40 for illuminating a remote object 8. The received reflected signal, having passed through the optics, is detected by the light sensitive detector 4. The signal is supplied to an analogue to digital converter 42 clocked at the master clock rate Fmck.

An MLS generator 34 generates the MLS signal. The MLS generator clock signal Fmls is derived from the system master clock Fmck of the master clock generator 36 by a divider 38 so that the MLS clock frequency is a known sub-multiple M of the master clock signal. In effect, the MLS is stretched in time by factor M. The “stretched” MLS signal causes the laser to emit an optical stretched MLS signal, the returned signal from the objects in the field of view being digitised and passed to coarse and fine cross-correlation calculation units.

The coarse cross-correlation unit 44 is clocked at the MLS clock frequency and hence correlates a sub-sampled version of the digitised reflected MLS signal and original stretched MLS transmitted signal 40. The output from this cross correlation unit is a peak which is detected by peak detector 48 and which indicates the coarse time delay of the reflected signal.

The control electronics 50 then causes the fine cross-correlator 46 to calculate the cross-correlation of the transmitted and reflected signals only in the region of the calculated coarse time delay. Typically, the fine cross-correlation function would be calculated for 2M samples before and after the coarse time delay. The output of the fine cross correlator 46 is the cross correlation function of the transmitted and reflected signals in the region of the peak, and is provided in response to a control input 32.

The shape of the correlation peak for a PRBS signal such as an MLS is a triangular pulse. The cross-correlation operation may be viewed as being similar to convolving the MLS with a delayed version of itself and then sampling the result at a frequency equal to the cross correlator clock frequency. Therefore, the shape of the correlation peak output by the cross-correlation unit is given by the convolution function of two identical pulses of width T, which is a triangular pulse sampled by the cross correlator clock frequency.

The image analysis apparatus also provides the azimuth and elevation of those points within the field of view which are nearer than the safe distance threshold and this information can be used to give an indication to the driver of where the potential collision may arise. For example, one of an array or light emitting diodes may be illuminated.

The collision avoidance system uses a photodiode array as the optical receiver.

The collision avoidance system described above includes an optical output device in the form of laser, a modulator for modulating the output of the laser to enable a data sequence (the MLS sequence) to be encoded by the optical output, and an optical receiver for receiving and decoding a modulated optical signal from a wide field of view. These components are capable of detecting high frequency modulation and of producing a high frequency digitally modulated light output.

This invention provides a vehicle safety system which uses these hardware components of a collision avoidance system to implement a communications interface which forms part of a traffic management or monitoring system. The hardware of the collision avoidance system can thus be used to enable future planned intelligent transportation systems to be implemented, at minimum cost, by taking advantage of a combined, low cost collision warning and communications sensor.

As shown schematically in FIG. 3, the common requirement for traffic management or monitoring systems is that a wireless communications link 60 is established between a vehicle 62 and a road-side transponder 64.

FIG. 4 shows the system of the invention. A single photodiode array 70 performs the functions of the optical receiver for the returned MLS range-finding signals and for data communications with the road side transponder 64. Similarly, a modulator 72 and optical emitter 74 perform the function of sending the MLS range-finding signals and data communications signals for the road side transponder 64.

One simple embodiment of the photodiode array to enable both range-finding and reception of communications simultaneously is shown in FIG. 5. Here the light detector comprises four photodiodes (PD11 to PD22) which are connected to amplifiers (A11 to A22). The output of each amplifier is connected to the range-finding processor via a switch transistor (TR11 to TR22) and also to the communications circuitry via mixing resistors (R11 to R22).

The photodiode array 70 can be operated in different modes for the different functions.

For range-finding, the switch transistors are used to sequentially couple each photodiode to the range-finding processor to measure the time of flight and hence range to objects within each photodiode field of view

For communications, the resistors mix together the outputs of each of the photodiodes to enable the detection of communications signals incident upon any of the photodiodes in the array. This allows the whole of the array to be sensitive at all times to communications signals, whilst still allowing individual photodiodes to be addressed for range-finding.

FIG. 4 shows separate processors 84,86 for the range-finding operation (processor 84) and the communications operation (processor 86). Again, these may be implemented by a single processor.

There are many different ways to enable the system to perform both functions with minimal interference between communications and range-finding operations.

In one possible approach, the operating time of the emissions from the vehicle is switched sequentially between range-finding and communications as illustrated in FIG. 6.

As shown, the vehicle communications are divided into frames, and each frame has a portion in which range-finding signals are sent and a portion in which communications signals are modulated. Similarly, the road side transponder sends signals to the vehicle oily during a particular period of the frame.

The ratio of time spent by the vehicle in communications or range-finding can be set dependant upon the level of information to be transmitted and the maximum detection range required of the rangefinder.

This approach has the advantage that the modulated light output from the vehicle can be binary in form (i.e. illumination is On or Off) which simplifies the high frequency drive circuitry for the optical emitter.

It will be seen that during the period of range-finding operation of the vehicle, the vehicle detector will be collecting both reflected rangefinder modulation and transponder communications signals. It is important to avoid interference between these two signals and there are many ways in which this can be achieved. One simple approach is to use a carrier signal for the communications modulation which is the same as the ADC sample rate of the rangefinder system. The benefit of this is that the carrier communications carrier frequency will only yield a DC offset (i.e. by Nyquist's sampling theorem the alias frequency is zero) which can be readily filtered out by the low pass filter used to reject ambient illumination prior to the analogue to digital converter (ADC) in the rangefinder detector circuitry. A further benefit is that by using a bandpass filter centred on the carrier frequency at the input to the communications processing circuitry, the communications processor can detect the presence of a transponder through the presence of a carrier signal.

The communications carrier signal can be modulated using any of a number of standard modulation/data encoding schemes and protocols, although care is needed with the modulation scheme as modulation creates side bands which no longer have an alias frequency of zero and therefore could affect rangefinder operation.

One approach is to take advantage of the nature of the rangefinder modulation to minimise cross talk with other systems. For example, the maximal length sequence emitted for range-finding repeats after Nmls ADC clock cycles, where:

Nmls=k·2^{r-1}

### And

k=oversampling factor

r=number of maximal length sequence shift register stages.

For automotive applications, the length of the oversampled maximal length sequence is typically set to be approximately 2 μs to avoid the risk of range ambiguity over an operating range of up to 300 m.

If the modulation sequence for communications is arranged so that it contains one logic 1 and one logic 0 during each oversampled MLS cycle (i.e. each bit is transmitted in a 2 μs, giving a data rate of 500K bits per second (bps)) the cross correlation operation used in the receiver to extract the MLS for range-finding will largely reject the communications modulation.

This may be seen by considering the case where a phase shifted modulation scheme is used with one logic 1 and one logic 0 per MLS cycle, as shown in FIG. 7.

Because the cross correlation operation with a maximal length sequence is equivalent to adding ((2^{r})/2)−1 samples multiplied by +1/(2^{r-1}) and ((2^{r})/2) samples multiplied by −1/(2^{r-1}) it can be seen that the cross correlation output from either logic 1 or logic 0 illustrated in FIG. 7 will be 1/(2^{r-1}), i.e. the cross-correlation output is reduced in amplitude by (2^{r-1}). A sufficiently long MLS shift register can be used to make the cross correlation output of the communications signal negligible.

The rejection of the communications signal can be further improved by using a slight modification to the maximal length sequence in the form of an extra pulse (or number of pulses) added at an appropriate point in each MLS cycle; i.e. an “MLS+1” signal. In this case, the length of the MLS+1 signal is an even number of samples and the cross correlation results in an output of zero for an appropriately chosen modulation scheme.

It can be seen that with the modulation system described above, it is possible both to establish a communications link between a vehicle and a road side transponder at a bit rate of ˜500 Kbps whilst at the same time providing range data for collision wanting and avoidance purposes.

It is advantageous, but not essential, if the transponder optical system and road layout is configured such that the emissions from the transponder can be only seen by one vehicle at a time. This is because a simpler communications protocol can be used if the transponder emissions can only seen by one vehicle at a time which increases the amount of time available for data transmission.

It will be apparent to those skilled in the art that other approaches are possible which benefit from the key concept of this invention; using the same emitter/detector on a vehicle for collision warning/avoidance and communications.

As discussed above, the collision warning system is able to identify which pixel or pixels receive reflected illumination from a vehicle in front. This information can also be used to advantage for vehicle to vehicle communications, as these same pixel or pixels are those which could be monitored to receive a modulated light signal emitted by the vehicle in front for communications purposes. Therefore, the system can choose which pixel to monitor for communications from the vehicle in front rather than monitoring all pixels simultaneously.

The light emitter is preferably arranged to operate at near infra red wavelengths to maximise penetration and range, even in the presence of rain, snow or fog. Although the use of lasers has been described, the light source used may be implemented either using a laser, high power light emitting diode (LED) or array of LEDs.

The system described in detail above uses course and fine cross correlation in the range-finding application. This is of course not essential and other implementations of range-finding are equally possible. The system can be implemented using optical communications frequencies as outline above, but can also be implemented using other frequencies such as microwave frequencies.

1. A vehicle safety system, comprising:
a collision avoidance system, comprising range finding apparatus for determining a distance to an adjacent vehicle, the collision avoidance system comprising a transmitter and a receiver; and
a communications system for communicating with a road side terminal, the communications system using the same transmitter and receiver respectively to send and receive data to and from the road side terminal,
wherein the collision avoidance system comprises a sequence generator for generating a modulation signal, and a cross-correlator for obtaining the time delay of a time delayed reflected modulation signal from a comparison of the modulation signal and the time delayed reflected modulation signal,
and wherein the communications system comprises a modulator for providing a modulated light output, wherein the modulated output has a low cross correlation with the sequence generator sequence.

2. A system as claimed in claim 1, wherein the sequence generator comprises a maximal length sequence generator.

3. A system as claimed in claim 2, wherein the sequence generator generates a repeating sequence of length k·2^{r-1} bits, wherein 2^{r-1} is the length of a maximal length sequence and k is an oversampling factor.

4. A system as claimed in claim 3, wherein the k·2^{r-1} bits are transmitted at a bit rate such that they have a transmission duration of 1-10 microseconds.

5. A system as claimed in claim 3 or 4, wherein an analogue to digital converter is provided for the received data, and wherein the communications signal is modulated on a carrier signal having a frequency corresponding to the clock rate of the analogue to digital converter.

6. A system as claimed in claim 3 or 4, wherein the bit period of the communications signal corresponds to the transmission duration of the k·2^{r-1} bits.

7. A system as claimed in claim 6, wherein each bit of the communications signal comprises one of two possible patterns of 0 and 1 within the bit period.

8. A system as claimed in any preceding claim, wherein the sequence generator provides as output a maximal length sequence extended by a plurality of bits.

9. A system as claimed in claim 8, wherein the sequence generator provides as output a maximal length sequence extended by one bit.

10. A system as claimed in any preceding claim, wherein a shared receiver of the communications system and the collision avoidance system comprises an optical receiver.

11. A system as claimed in claim 10, wherein the optical receiver comprises a multiple-region light detector for detecting light received from the receiving optics, wherein different regions of the light detector can be actuated separately.

12. A system as claimed in claim 11, wherein the optical receiver comprises a multiple-region light detector, wherein the communications system monitors simultaneously all regions of the light detector.

13. A system as claimed in claim 12, wherein the optical receiver comprises a one or two dimensional photodiode array.

14. A system as claimed in claim 13, wherein the photodiode array is operable in a first mode in which charges are stored on all photodiodes of the array in response to light input and read out to capture image data, and a second mode in which the signals from selected individual photodiodes or sub-groups of photodiodes are routed, in a sequence, to the processing means.

15. A system as claimed in claim 12, 13 or 14, wherein the collision avoidance system further comprises:
control electronics to synchronise the timing and control of illumination of the light source and the actuation of the light detector; and
processing means for measuring the time of flight of light signals from the light source to the actuated portion of the detector for all illuminated directions and deriving distances from the times of flight.

16. A system as claimed in claim 15, wherein the cross correlator is arranged to carry out the steps of:
determining, at a coarse resolution, the time delay of the modulation signal needed to maximise the correlation between the time delayed modulation signal and the modulation signal,
determining at a finer resolution than the coarse resolution, the correlation between the time delayed modulation signal and modulation signal as a function of the time delay of the time delayed modulation signal with respect to the modulation signal in a time delay range around the determined time delay, and
outputting a measure of distance calculated from the time delay of the modulation signal needed to maximise the correlation between the time delayed modulation signal and the modulation signal.

17. A system as claimed in claim 15 or 16, wherein the cross-correlator comprises:
a coarse cross-correlator for coarsely determining the time delay of the modulation signal needed to maximise the correlation between the time delayed modulation signal and the modulation signal, and
a fine cross-correlator for calculating the correlation between the time delayed modulation signal and the modulation signal as a function of the time delay of the modulation signal with respect to the received signal in a time delay range around the time shift determined by the coarse cross-correlator.

18. A system as claimed in claim 17, wherein the ratio of coarse cross-correlator and fine cross-correlator operating frequencies is adjusted to minimise interference between adjacent systems.

19. A system as claimed in claim 17 or 18, wherein the coarse cross correlator is clocked at a first frequency and the fine cross-correlator is clocked at a higher second frequency.

20. A system as claimed in any preceding claim, wherein the collision avoidance system further comprises:
means for illuminating a field of view of interest with the optical transmitter output signal; and
receiving optics for receiving light reflected from the field of view to be analysed.

21. A system as claimed in any preceding claim, wherein the communications system is further for communicating with an adjacent vehicle.

22. A vehicle safety system, comprising:
a collision avoidance system, comprising range finding apparatus for determining a distance to an adjacent vehicle, the collision avoidance system comprising a transmitter and a receiver; and
a communications system for communicating with a road side terminal, the communications system using the same transmitter and receiver respectively to send and receive data to and from the road side terminal,
wherein the collision avoidance system comprises a sequence generator for generating a modulation signal, and a cross-correlator for obtaining the time delay of a time delayed reflected modulation signal from a comparison of the modulation signal and the time delayed reflected modulation signal,
and wherein the transmitter comprises a laser arrangement and the receiver comprise an optical detector.
